(19) United States
(12) Patent Application Publication
(10) Pub. No.: US 2016/0344641 A1
(43) Pub. Date: Nov. 24, 2016

(54) ARCHITECTURE AND CONTROL PLANE FOR DATA CENTERS

(71) Applicant: The Regents of the University of California, Oakland, CA (US)

(72) Inventors: Tara Javidi, San Diego, CA (US); Chang-Heng Wang, La Jolla, CA (US); Tugcan Aktas, La Jolla, CA (US)

(21) Appl. No.: 15/161,847

(22) Filed: May 23, 2016

Related U.S. Application Data
(60) Provisional application No. 62/165,805, filed on May 22, 2015.

(51) Int. Cl. H04L 12/841; H04L 12/863; H04L 12/26; H04W 4/00

(52) U.S. Cl. CPC H04L 47/283; H04W 4/008; H04L 47/50; H04L 43/0852

(57) ABSTRACT

Systems and methods according to present principles provide an architecture for data center networks with many, e.g., possibly up to thousands, top of rack (ToR) switches, by employing an architecture that relies on a separation of the data and the control planes. While the data is switched between the ToR switches in an all-optical high rate network, network state and control information is continuously transmitted and received from a central unit (also termed a control unit or centralized unit) over an ultra-low-latency wireless/wired network.

### CROSS-REFERENCE TO RELATED APPLICATIONS

This application claims benefit of priority to U.S. Provisional Patent Application Ser. No. 62/165,805, filed May 22, 2015, entitled “ARCHITECTURE AND CONTROL PLANE FOR DATA CENTERS”, owned by the assignee of the present application and herein incorporated by reference in its entirety.

### GOVERNMENT FUNDING

This invention was made with government support under EEC-0812072 awarded by the National Science Foundation for Integrated Access Networks. The government has certain rights in the invention.

### BACKGROUND

It is known that internet style transportation of data puts the emphasis on distributed operations and scalability. On the other hand, data center networking can significantly depart from classical and internet-inherited networking in order to allow fine-grain management and scheduling of the flows of data. This departure from classical networking has been motivated by the fact that any given data center is generally managed, more or less, by a single entity, e.g. Google®, Facebook®, or Twitter®.

While certain prior solutions have concentrated on operating the control and the data plane on a single medium, the ensuing systems have resulted in degraded latency performance in both monitoring and the schedule distribution. Moreover, such systems have the inherent disadvantage of steering delays related to the slow realignment of optical mirrors, which makes it difficult for the controller to reach the up-to-date traffic demand of the racks. For example, an all wireless data center design has been proposed where the data is transmitted over wireless links which are inherently of lower capacity. Another attempt is a wireless facility network which is a multi-hop wireless network that provides an auxiliary network for facility bring up and installation and for forwarding table updates and reset hardware in response to electronic switch failures in the data plane. Such attempts have certain deficiencies and are associated with various disadvantages.

This Background is provided to introduce a brief context for the Summary and Detailed Description that follow. This Background is not intended to be an aid in determining the scope of the claimed subject matter nor be viewed as limiting the claimed subject matter to implementations that solve any or all of the disadvantages or problems presented above.

### SUMMARY

In one implementation, systems and methods according to present principles provide an architecture for data center networks with many, e.g., possibly up to thousands, top of rack (ToR) switches. In more detail, in large data centers, the server computers are almost always organized into physical racks for ease of hierarchical management, maintenance, and improved space utilization. In most modern data center networks, tens or up to 100 server computers are located in one such rack. Therefore, the communication between any two server computers residing in different racks requires a connection between the corresponding two racks. The physical unit making communication possible between two racks and between a rack and the central unit in an on-off fashion is called a top of rack (ToR) switch.

Systems and methods according to present principles employ an architecture that relies on a separation of the data and the control planes. While the data is switched between the ToR switches in an all-optical high rate network, the network state and control information 35 is continuously transmitted and received from a central unit (also termed a control unit or centralized unit) over an ultra-low-latency wireless/wired network. While systems and methods according to present principles described here generally relate to a wireless control plane serving an all optical data center, the same is simply intended for example purposes, and other types of networks are also encompassed by systems and methods according to present principles.

One exemplary technical challenge handled by systems and methods according to present principles is the design of end-end circuit switching mechanisms that account for monitoring as well as circuit reconfiguration delays. Thus what is provided is an architecture with increased level of efficiency and significantly smaller latency, relying on the unique attributes of data centers.

In more detail, it is generally important in all data centers that the monitoring of the network states, the calculation of efficient schedules and the distribution of these schedules (see link 37), are carried out with high frequency. Systems and methods according to present principles in part improve the latency of the monitoring and the schedule distribution operations, which are together known as the control plane of a data center. The systems and methods of handling the control plane jobs rely in one implementation on a single-hop wireless and/or wired communication of the control plane data in a decoupled manner from the data plane transmissions, which generally relate to data packet transit and transmissions. Thus the systems and methods are applicable irrespective of the exact implementation details of the data plane. The systems and methods in one implementation may assume a single centralized unit that closely observes and manages the network state. As an example, the communications between the network nodes that are called as ToR switches and this central unit may be via beam formed signals in the, e.g., wireless medium for improved signal strengths and decreased interference.

Systems and methods according to present principles may deviate from prior work on (near-) zero in-network queuing in that a hybrid architecture is employed including physically distinct monitoring/control and data planes. The physical separation and decoupling of the monitoring/control plane from the data plane allows for the optimization of the attributes of each component of the network.

In a lower level, the decoupling is generally the separation of the physical layers over which monitoring and control information, and switched packet data are conveyed. This in turn allows the flexibility of separating the design of operations and hence their timescales in a more abstract higher level. Hence, in this context, the decoupling is the separation of the design of algorithms and the design of equipment for the monitoring and the control plane from those of the data plane.

A central controller may be employed that exercises tight or very tight control over end-end flows by way of a dynamic (fine-grained) circuit switching in the data plane, including which ToR switch can send packets, and what paths packets take. The dynamic fine-grained circuit switching matches the flow rates to the available network capacity at the time scales of the monitoring and control instead of matching the rates over longer time-scales as is done with distributed congestion control.

A second component is a dedicated (and physically distinct) network providing a secure, reliable, and ultra-low latency channel from ToR and core switches to and from the centralized controller. In other words, the monitoring and control functionalities (which are critical for fine-grained dynamic circuit switching) are pushed away from the data-plane into an entirely separate network which is optimized for ultra-low-latency operation for monitoring traffic demands and control of switches. For example, in one implementation, the 99th percentile latency experienced by the data packets is 320 microseconds, which can constitute a good upper bound for the proposed architecture, since the same further gains from decoupling of the control plane.

Consequently, systems and methods according to present principles satisfy an important property required by data centers: scalability. That is, even with hundreds of ToR switches, the monitoring/control plane does not impose any extra pressure on the data plane, which is a main disadvantage with the existing art.

In one aspect, the invention is directed towards a network architecture which employs attributes of a data center to enable an increased level of efficiency and reduced latency, including: a control plane, the control plane operable to monitor and schedule distribution operations, the control plane including a central unit; and a data plane distinct from the control plane, the data plane operable to enable data packet transit, wherein the control plane and the data plane are decoupled, whereby timescales associated with network monitoring and control and switching of data are decoupled.

Implementations of the invention may include one or more of the following. The control plane may operate using a wireless technology and the data plane operates using a wired technology. The wireless technology may be a wireless single hop technology. The wireless technology may use millimeter wave communications. The control plane may be physically separated from the data plane, and may communicate with the data plane wirelessly or in a wired fashion. The wireless technology may correspond to a communication scheme that accesses top of rack (ToR) switches. The central unit may transmit and receive network state and control information to and from the ToR switches. The transmission and reception of network state and control information may be via beam formed signals, which may be digitally modulated using a spatially adaptive version of OFDMA. The central unit may be operable to optimize circuit switching to account for and schedule data packets queued at an edge of the network at at least one ToR switch so as to minimize delay in the data plane. The central unit may be operable to monitor traffic demands across the data center, calculate schedules for packet transmissions, and transmit the calculated schedules to the ToR switches. The control plane may be operable to exercise control over data flows by way of a dynamic circuit switching in the data plane, including which ToR switch sends packets, and what paths packets take.

In another aspect, the invention is directed towards a method of organizing data communications in a data center, including: in a data center of a network, monitoring and scheduling distribution operations using a control plane, the control plane including a central unit, the monitoring and scheduling distribution operations performed by communicating with a plurality of top of rack (ToR) switches; and in the data center, causing data traffic in a data plane, the data plane decoupled from the control plane, such that decoupling of the control plane from the data plane decouples timescales associated with network monitoring and control and switching of data, whereby timescales associated with the planes may be optimized in a decoupled fashion.

Implementations of the invention may include one or more of the following. The communicating may be by way of beam formed signals. The method may further comprise basing control signals on a location of the ToR switches in the data center so as to maintain message transmission for the ToR switches at a minimum. The monitoring and scheduling distribution operations may exercise control over data flows by causing dynamic circuit switching in the data plane, including determining which ToR switch sends packets, and what paths packets take. The monitoring and scheduling distribution operations may utilize optical switching, and may further include shifting buffering of information packets to the ToR switches. The buffering of information may be shifted to ToR switches at edges of the network, so as to enable low end-to-end packet delay in the data plane. An upper bound of the end-to-end packet delay may be 320 μs.

In a further aspect, the invention is directed to a non-transitory computer readable medium, comprising instructions for causing a computing environment to perform the above steps.

Advantages of the invention may include, in certain embodiments, one or more of the following. In another implementation, systems and methods according to present principles decrease the time spent for control plane operations in a very large data center. Systems and methods according to present principles provide a solution to the data flow latency problem for very large data centers via a clean-slate architecture that is scalable, cost-efficient and has low-complexity of implementation. Systems and methods according to present principles further provide a reliable solution for companies that are in need of supporting tens of thousands of server computers under a single data center structure with very low end-to-end delay, and hence systems and methods disclosed provide an improved user experience.

Other advantages of certain implementations include that the decoupling of the control plane from the data plane allows for the effective optimization of the attributes of the control plane. In some existing architectures, the control plane messages usually share the same transmission medium with the data plane packets. This has drawbacks related to both the complexity of the implementation and the utilization of the available throughput. With systems and methods according to present principles, once the control plane is physically separated from the data plane, it is possible to increase the frequency of the monitoring of the network states (and also the frequency of the schedule distribution) without imposing any increased burden of data traffic on the data plane. In that sense, the systems and methods according to present principles eliminate the need for special traffic constraints, e.g., higher priority control plane messages, on the data plane, and do not degrade the end-to-end throughput observed between any nodes in the data center. On the contrary, by the help of the improvements in the monitoring frequency in a separate single-hop wireless/wired network that is controlled by a single centralized unit, the systems and methods provided are able to supply the scheduler of the data plane with up-to-date network state (traffic demand) information for reaching even higher throughputs as a result of the calculated efficient schedules. Furthermore, the systems and methods provided incorporate a careful examination of the unique properties of the communication environment in a data center for decreased latency in the control plane. From this perspective, the systems and methods are applicable for very densely distributed server racks in a large data center that is composed of hundreds of ToR switches. Moreover, the systems and methods may serve as a flexible control plane without the cost and the thermal management problems of wired counterparts in case the control plane is realized using wireless technologies.

Other advantages will be understood from the description that follows, including the figures and claims.

This Summary is provided to introduce a selection of concepts in a simplified form. The concepts are further described in the Detailed Description section. Elements or steps other than those described in this Summary are possible, and no element or step is necessarily required. This Summary is not intended to identify key features or essential features of the claimed subject matter, nor is it intended for use as an aid in determining the scope of the claimed subject matter. The claimed subject matter is not limited to implementations that solve any or all disadvantages noted in any part of this disclosure.

### BRIEF DESCRIPTION OF THE DRAWINGS

FIG. 1 illustrates an arrangement according to present principles of a wireless control plane enabling an all-optical data plane.

FIG. 2 is an illustration of a dynamic circuit-switched network of N ToRs according to present principles.

FIG. 3 illustrates a simulation of monitoring delays with respect to the number of ToRs.

FIG. 4 is a flowchart of a method according to present principles.

Like reference numerals refer to like elements throughout. Elements are not to scale unless otherwise noted.

### DESCRIPTION

As noted above, systems and methods according to present principles allow for data flows to be optimally scheduled across a network via a clean-slate architecture and a rethinking of the protocol stack.

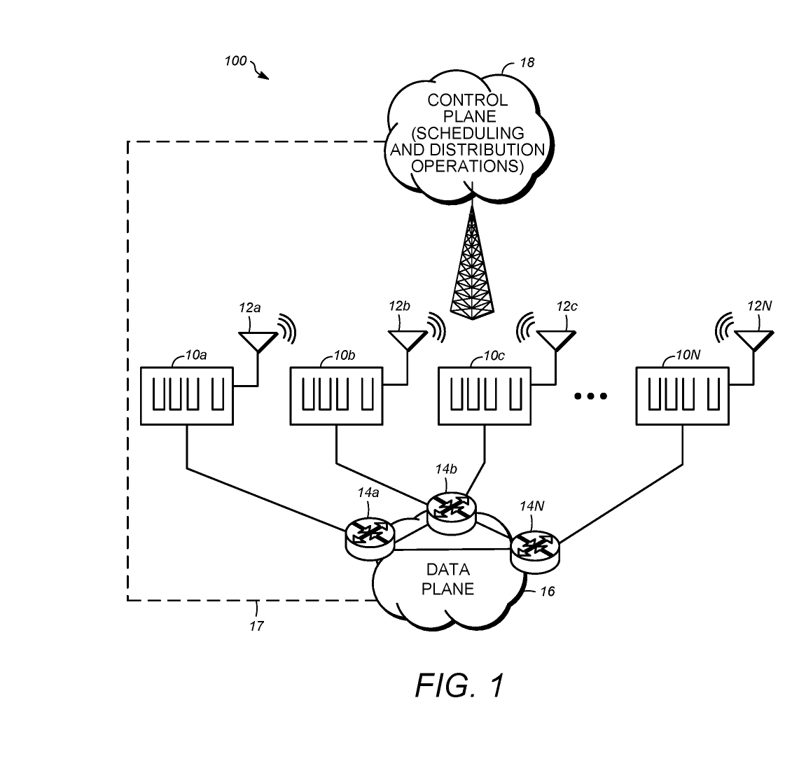

FIG. 1 shows an illustration for one implementation of an architecture 100 according to present principles. In the architecture 100, a number of devices 10a-10N are shown with respective wireless transceivers 12a-12N and the same are communicating using the transceivers to a control plane 18. The devices 10a-10N may vary, but are generally embodied as servers, and in the case of FIG. 1 are shown as racks with illustrated message queues. As noted, while wireless is shown, other types of communications and protocols may also be employed, including direct wired communications, as indicated by connection 17. A separate data plane 16 is also illustrated in communication with the devices 10a-10N through switches 14a-14N. One aspect of this architecture is that the architecture fully decouples the time scales associated with network monitoring and control and optical switching of data, and allows for the optimization of the attributes of each component of the network.

In more detail, modern data centers usually include hundreds to thousands of servers, and intensive data exchanges occur within a data center network, which is assumed to be operated by a single entity. Ever increasing data-rate requirements (40 Gbps, 100 Gbps, or beyond) and numbers of port counts have become bottlenecks for traditional electronic data switches. Optical switches have an advantage in scalability and lower power consumption. In addition, the ever decreasing switching time in optical switches (due to MEMS mirrors, etc.) makes the boundary between circuit switching time scales and packet switching shift and blur somewhat.

In one aspect, a centralized controller is provided that exercises tight control over end-end flows in the form of a dynamic or fine-grained circuit switching in the data plane, which top of rack (ToR) switch can send packets and what paths packets take. Such circuit switching matches the flow rates to the available network capacity at the time scales of the monitoring and control instead of matching the rates over longer timescales as is done with distributed congestion control. In this way, the optimized operation of the data plane depends on how tight the monitoring and control of the centralized scheduler is relative to the dynamics of the traffic demand across the network.

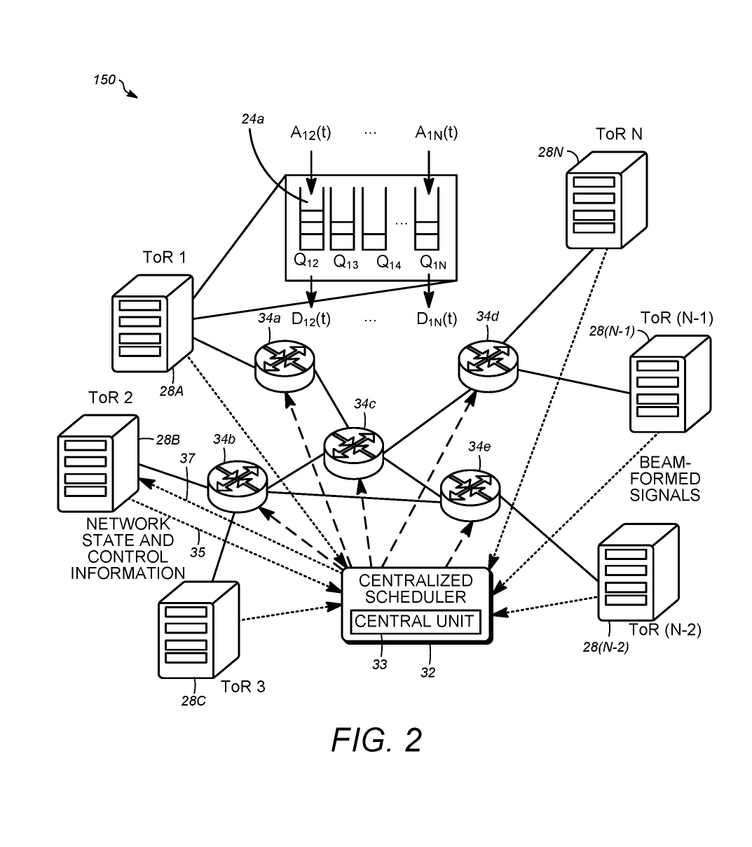

A data plane according to present principles may be implemented using all optical switching where dynamic circuit switching maintains the operation basis. However, it is noted that optical switching comes with certain challenges of its own. Buffering of information packets is not feasible in the optical domain. This means that utilizing optical switching in a data center requires fine-grain circuit switching, and hence, shifting the buffering to the ToR switches at the edge of the network (see FIG. 2). This in turn results in a network that is abstracted as a generalized switch with non-zero reconfiguration and monitoring delays.

That is, from the point of view of the central unit, the top of rack (ToR) switches are the end nodes of the network. A ToR switch requires transfer of data to and from other ToR switches and needs to maintain a buffer for each destination ToR switch since it is not feasible, if not impossible, to implement an optical buffer within the optical network. Therefore, the buffer of waiting data packets should be kept at the end nodes (ToR switches) which define the edge of the network.

Therefore, systems and methods according to present principles may take advantage of an optimized circuit switching strategy that accounts for and schedules the outstanding traffic packets queued up at the edge of the network at each ToR switch with the ultimate goal of having low delay in the data plane. Furthermore, the low delay performance of the data plane switching strategy may be highly sensitive not only to the reconfiguration delays but also to the monitoring delays.

In more detail, and referring to FIG. 2, physically separated networks are illustrated (not just logically separated networks). In particular, a set of N ToR switches 28ₐ-28_{N} are illustrated which are interconnected by a network. Each switch 28i can serve as a source and the destination simultaneously. A desire is no- or minimized queuing in the core network, hence all or most the queuing occurs in the edge of the network, i.e., within the switches 28i. Each switch 28i maintains N−1 edge queues 24a-24M, either physically or virtually, which are denoted by Q₁₂-Q_{1N} in FIG. 2 (just one set of queues corresponding to ToR 1 is illustrated). Aᵢⱼ(t) and Dᵢⱼ(t) denote the number of packets arrived and departed from Qᵢⱼ at time t. A centralized scheduler 32 is shown, having a central unit 33, along with elements 34i, these elements forming a part or unit of the “programmable optical switching fabric” that interconnects the ToR switches, and thus constituting a physical entity with one or more fiber optical inputs and more than one fiber optical output and providing a selective connection property between the input(s) and the output(s). The dynamic and fine-grained circuit switching according to present principles generalizes ideas from switch fabric scheduling to manage circuit scheduling at fast and fine-grained timescales. The centralized scheduler selects the schedule so as to minimize the latency at the edge queues.

The need for low-latency monitoring of the network state is addressed by another aspect of systems and methods according to present principles. In particular, a centralized wireless monitoring/control plane including a central unit 33 serving the data plane is given as an example possible implementation. Wireless technology, if carefully optimized across layers of the protocol stack, provides a cost-effective solution for a monitoring/control plane such that a zero-buffer circuit switch is established at appropriate time scales. Given the tight latency requirements, the wireless monitoring of a data center has certain challenges and opportunities. Considering the environment of densely packed racks in a data center with relatively short distances between communicating units, mmWave communication is used.

To start with, a large bandwidth, spanning several Ghz, has been allocated for unlicensed use around 60 GHz which may be employed to realize short-range, high-rate wireless communications as required in the monitoring/control plane of a data center. Moreover, systems and methods according to present principles may use multiple antenna systems and beamforming that are also practical for millimeter wave communications and which is preferable to compensate for the very high propagation losses in this band.

The systems and methods according to present principles may further use a central unit (CU) that monitors the current instantaneous traffic demands across the data center (monitoring), calculating efficient schedules for packet transmissions, and making the resulting schedules available at the top of rack (ToR) switches. The systems and methods provided may use a single-hop wireless network design to implement the communication link to and from the CU (monitoring/control plane). Such a wireless data-center-wide monitoring plane is expected to improve the throughput in both optical and electrical data plane implementations.

In one aspect, the systems and methods according to present principles provide a bridge between the ToR switches and the CU for both monitoring and control functionalities. However, the monitoring plane (uplink) objective may be focused on, as distributing schedules (control) across the network can be achieved with a relatively low rate (broadcasting a sparse set of end-end flow connectivities). In contrast, the monitoring plane is required to achieve low-latency and high reliability communication for hundreds of ToR switches densely packed in a small area.

Systems and methods according to present principles ensure that the CU has a low latency update regarding the backlog information across the network. In other words, each ToR switch is responsible to update the CU on the amount of traffic it has for all other ToRs. However, it is known that the queue backlogs at consecutive time intervals are highly correlated. This temporal correlation of size of a queue may be used to design monitoring messages to be that of differential queue occupancy information (instead of the exact queue sizes). At the same time, since each ToR switch has the same number of edge queues, the message size is designed to be fixed across all ToR switches. In other words, the differential backlog information may be quantized into a given number of bits that are sufficient to reconstruct the exact information at the CU if the monitoring plane is reliable. Particularly, in case the monitoring frequency is high enough, the interval between two monitoring phases would be small so that differences in the queue sizes may also be represented by a very small number of bits. Once this message rate and the desired reliability of message transmission (usually in terms of bit-error-rate (BER)) are fixed over the network of ToR switches, the monitoring algorithms may be designed to manage the resources spatially and minimize the monitoring delay. In other words, by taking the data center layout into consideration, systems and methods according to present principles may make use of the degrees of freedom corresponding to each ToR's unique location in the data center in order to keep message transmission for all ToR switches at a minimum. In particular, the major challenge is managing the aggregate rate for large data centers with potentially hundreds of ToRs.

In order to manage the rate requirement, as noted, systems and methods according to present principles may make use of mmWave transmissions, e.g., around 60 GHz for the radio access between a ToR switch and the CU. mmWave-band communications have advantages in short distance communications: small channel delay spreads due to high path loss, large and unlicensed transmission bandwidth, and potential applications of massive Multiple Input Multiple Output (MIMO) antenna systems and beamforming. Although the propagation and the atmospheric losses are immense in the mmWave channel, use of narrow beams is a common method to solve the problem of low average received signal-noise-power-ratio (SNR) values.

When combined with beamforming, the mmWave communication results in relatively small channel delay spreads; however, still a multipath propagation problem might arise in a dense scatterer environment like the one in a data center. In order to counteract the resulting intersymbol interference (ISI) problem, the digital modulation scheme may be selected as a spatially adaptive version of Orthogonal Frequency Division Multiple Access (OFDMA). In addition to ISI mitigation, with an OFDM-type transmission, preferred subcarriers may be assigned to users in a multi-user scenario. Moreover, considering the large number of ToR switches communicating simultaneously, the simple receiver structure for OFDMA demodulation has a computational complexity advantage.

In the architecture according to present principles, the latency of monitoring should generally be low enough to achieve efficient schedules. On the other hand, channel codes should also be used to improve the end-to-end reliability. As a result, channel codes of short blocklength with relatively higher rates may be used. In one implementation, the channel code may be selected as an irregular low-density parity-check (LDPC) code, since LDPC code have a BER performance close to Shannon capacity.

A transmission mechanism that is adapted to the heterogeneity of the network of many ToR switches is a key point in achieving reliable and low-latency communication for monitoring purposes. In that sense, the OFDMA subcarriers may be allocated to the ToRs carefully so that the inherent frequency diversity that results from data center characteristics may be utilized. Other than frequency adaptivity, a huge variation of the received SNR values (due to difference in the distances of the ToRs to the CU) may also be taken into consideration. Consequently, an adaptation of the modulation size and/or channel coding rate may be employed for reliable transmission of all ToR switches. A macro-level resource allocation may be followed that includes two disjoint steps: Distance-based Rate Assignment and Greedy Frequency-time Resource Allocation for Low-magnitude Subcarrier Avoidance. The first phase of spatial adaptation considers only the distance dependent SNR values of the ToR switches in order to assign sensible modulation orders and channel code rates. After this assignment, the requested number of frequency-time resources is calculated in the second phase of adaptation.

The ToRs are then assigned these resources according to the greedy algorithm starting from the ToR for which the received SNR is minimum and continuing up to the ToR for which the received SNR is maximum. The implementation details for these algorithms and other system parameters for the systems and methods are given in the papers incorporated by reference below.

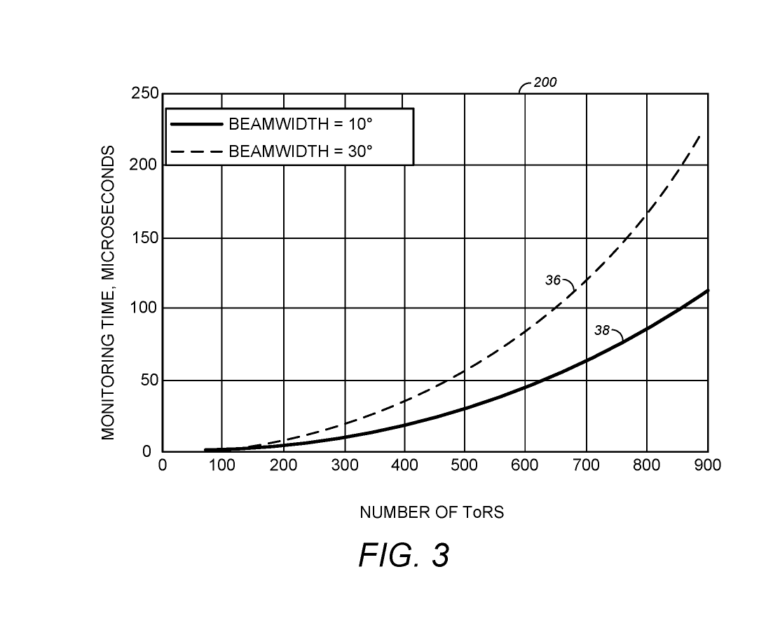

FIG. 3 is a graph 200 illustrating a simulation result for demonstrating the achievability of low monitoring latency with systems and methods according to present principles utilized for large data centers by making use of the state-of-the-art wireless technology. The monitoring delays for two different beamwidth values, 10° corresponding to curve 38, and 30° corresponding to curve 36, are given with respect to the increasing number of ToRs in the data center in the figure. Decreasing beamwidth three fold is equivalent to increasing transmit power by almost 9.5 dB. Clearly, systems and methods according to present principles are capable of keeping the monitoring latency under the 40 μs limit (an important performance measure for described data center scheduling operations in the papers incorporated by reference below), if the data center size is up to 550 and 450 ToR switches for beamwidths of 10 and 30 degrees respectively.

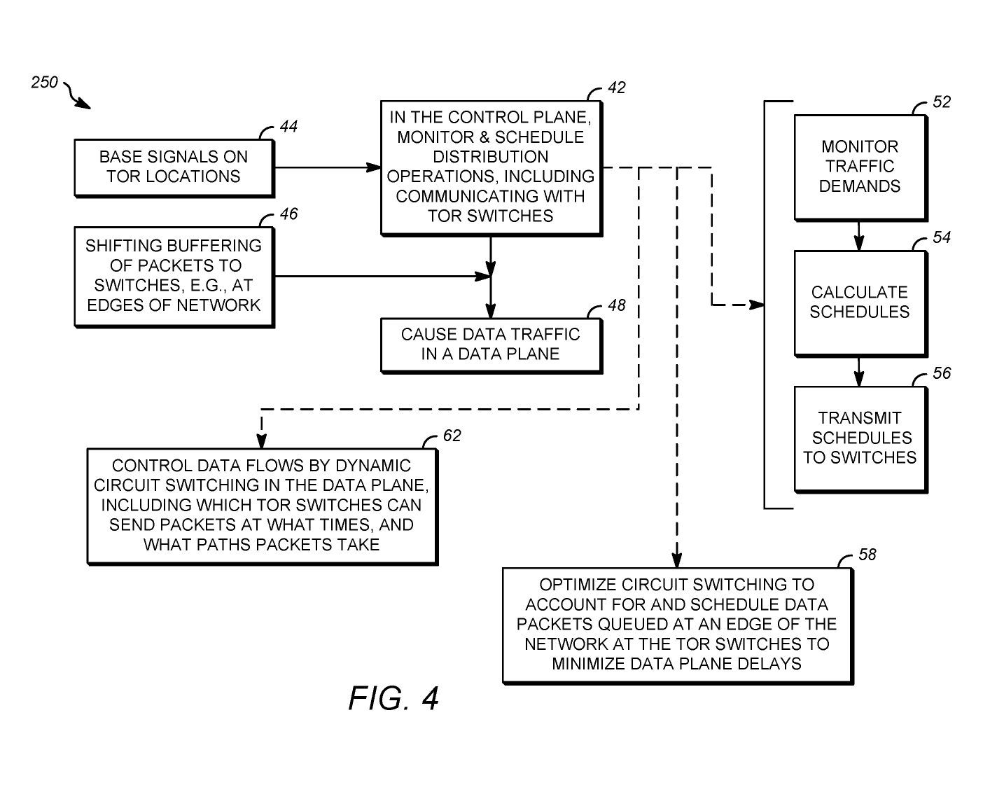

FIG. 4 is a flowchart 250 of a method of the invention. In a first step, and in a control plane, a central unit performs monitoring and schedule distribution operations, including communicating with switches such as ToR switches (step 42). In a next step, data traffic moves in a data plane according to the scheduling and other data from the control plane (step 48).

In variations, the monitoring and schedule distribution operations may be based, at least in part, on the physical locations of the ToR switches (step 44), as described in greater detail above. In yet another variation, the buffering of packets may be shifted to switches at the edge of the network (step 46).

In one implementation, the control plane may perform steps including monitoring traffic demands (step 52), calculating schedules (step 54) according to received information and data regarding network traffic, and transmitting schedules to the ToR switches (step 56). In another implementation, the central unit may be configured and operable to optimize circuit switching to account and schedule data packets queued at an edge of the network at the ToR switches, to minimize delays in the data plane. In yet another implementation, the central unit is configured and operable to control data flows by dynamic circuit switching in the data plane, including determining which ToR switches can send packets at what times, and what paths the data packets take.

Variations will be understood. For example, while data center implementations have been described here, other systems may also benefit, particularly where data plane and control plane separation may be effectively achieved. In addition, while ToR switches have been described, systems and methods according to present principles may be extended to systems involving other switching mechanisms.

Additional details regarding systems and methods according to present principles are provided in the following two papers:
T. Akta [symbol] , C. H. Wang and T. Javidi, “WiCOD: Wireless control plane serving an all-optical data center,” 13th International Symposium on Modeling and Optimization in Mobile, Ad Hoc, and Wireless Networks (WiOpt), 2015, Mumbai, 2015, pp. 299-306.
doi: 10.1109/WIOPT.2015.7151086
URL: http://ieeexplore.ieee.org/stamp/stamp.jsp?tp=&arnumber=7151086&isnumber=7151020
T. Javidi, C. H. Wang and T. Akta [symbol] , “A novel data center network architecture with zero in-network queuing,” 13th International Symposium on Modeling and Optimization in Mobile, Ad Hoc, and Wireless Networks (WiOpt), 2015, Mumbai, 2015, pp. 229-234.
doi: 10.1109/WIOPT.2015.7151077
URL: http://ieeexplore.ieee.org/stamp/stamp.jsp?tp=&arnumber=7151077&isnumber=7151020

Both of the above papers are incorporated by reference herein in their entireties.

The system and method may be fully implemented in any number of computing devices. Typically, instructions are laid out on computer readable media, generally non-transitory, and these instructions are sufficient to allow a processor in the computing device to implement the method of the invention. The computer readable medium may be a hard drive or solid state storage having instructions that, when run, are loaded into random access memory. Inputs to the application, e.g., from the plurality of users or from any one user, may be by any number of appropriate computer input devices. For example, users may employ a keyboard, mouse, touchscreen, joystick, trackpad, other pointing device, or any other such computer input device to input data relevant to the calculations. Data may also be input by way of an inserted memory chip, hard drive, flash drives, flash memory, optical media, magnetic media, or any other type of file—storing medium. The outputs may be delivered to a user by way of a video graphics card or integrated graphics chipset coupled to a display that may be seen by a user. Alternatively, a printer may be employed to output hard copies of the results. Given this teaching, any number of other tangible outputs will also be understood to be contemplated by the invention. For example, outputs may be stored on a memory chip, hard drive, flash drives, flash memory, optical media, magnetic media, or any other type of output. It should also be noted that the invention may be implemented on any number of different types of computing devices, e.g., personal computers, laptop computers, notebook computers, net book computers, handheld computers, personal digital assistants, mobile phones, smart phones, tablet computers, and also on devices specifically designed for these purpose. In one implementation, a user of a smart phone or Wi-Fi—connected device downloads a copy of the application to their device from a server using a wireless Internet connection. An appropriate authentication procedure and secure transaction process may provide for payment to be made to the seller. The application may download over the mobile connection, or over the WiFi or other wireless network connection. The application may then be run by the user. Such a networked system may provide a suitable computing environment for an implementation in which a plurality of users provide separate inputs to the system and method. In the below system where network architectures are contemplated, the plural inputs may allow plural users to input relevant data at the same time.

The above description details certain implementations. The scope of the invention is to be determined solely by the claims appended hereto, and equivalents thereof.

1. A network architecture which employs attributes of a data center to enable an increased level of efficiency and reduced latency, comprising:
a. a control plane, the control plane operable to monitor and schedule distribution operations, the control plane including a central unit; and
b. a data plane distinct from the control plane, the data plane operable to enable data packet transit,
c. wherein the control plane and the data plane are decoupled, whereby timescales associated with network monitoring and control and switching of data are decoupled.

2. The network architecture of claim 1, wherein the control plane operates using a wireless technology and the data plane operates using a wired technology.

3. The network architecture of claim 2, wherein the wireless technology is a wireless single hop technology.

4. The network architecture of claim 2, wherein the wireless technology uses millimeter wave communications.

5. The network architecture of claim 1, wherein the control plane is physically separated from the data plane.

6. The network architecture of claim 1, wherein the control plane communicates with the data plane wirelessly or in a wired fashion.

7. The network architecture of claim 2, wherein the wireless technology corresponds to a communication scheme that accesses top of rack (ToR) switches.

8. The network architecture of claim 7, wherein the central unit transmits and receives network state and control information to and from the ToR switches.

9. The network architecture of claim 8, wherein the transmission and reception of network state and control information is via beam formed signals.

10. The network architecture of claim 9, wherein the beam formed signals are digitally modulated using a spatially adaptive version of OFDMA.

11. The network architecture of claim 8, wherein the central unit is operable to optimize circuit switching to account for and schedule data packets queued at an edge of the network at at least one ToR switch so as to minimize delay in the data plane.

12. The network architecture of claim 8, wherein the central unit is operable to monitor traffic demands across the data center, calculate schedules for packet transmissions, and transmit the calculated schedules to the ToR switches.

13. The network architecture of claim 1, wherein the control plane is operable to exercise control over data flows by way of a dynamic circuit switching in the data plane, including which ToR switch sends packets, and what paths packets take.

14. A method of organizing data communications in a data center, comprising:
a. in a data center of a network, monitoring and scheduling distribution operations using a control plane, the control plane including a central unit, the monitoring and scheduling distribution operations performed by communicating with a plurality of top of rack (ToR) switches; and
b. in the data center, causing data traffic in a data plane, the data plane decoupled from the control plane,
c. such that decoupling of the control plane from the data plane decouples timescales associated with network monitoring and control and switching of data, whereby timescales associated with the planes may be optimized in a decoupled fashion.

15. The method of claim 14, wherein the communicating is by way of beam formed signals.

16. The method of claim 15, further comprising basing control signals on a location of the ToR switches in the data center so as to maintain message transmission for the ToR switches at a minimum.

17. The method of claim 14, wherein the monitoring and scheduling distribution operations exercise control over data flows by causing dynamic circuit switching in the data plane, including determining which ToR switch sends packets, and what paths packets take.

18. The method of claim 14, wherein the monitoring and scheduling distribution operations utilize optical switching, and further comprising shifting buffering of information packets to the ToR switches.

19. The method of claim 18, wherein the buffering of information is shifted to ToR switches at edges of the network, so as to enable low end-to-end packet delay in the data plane.

20. The method of claim 19, wherein an upper bound of the end-to-end packet delay is 320 μs.
